(19) United States
(12) Patent Application Publication
(10) Pub. No.: US 2017/0319316 A1
(43) Pub. Date: Nov. 9, 2017

(54) LIGATURES AND USE THEREOF

(71) Applicants: 4C DESIGN LIMITED, Glasgow (GB); MEAT & LIVESTOCK AUSTRALIA LIMITED, North Sydney, New South Wales (AU)

(72) Inventors: Robin SMITH, Glasgow (GB); William MITCHELL, Glasgow (GB); John RITCHIE, Glasgow (GB); Thomas HARRIS, Glasgow (GB); Michael ALDRIDGE, Glasgow (GB); Michael ANUSAS, Glasgow (GB); Mark PENVER, Glasgow (GB); John TARGELL, Glasgow (GB)

(73) Assignees: 4C DESIGN LIMITED, Glasgow (GB); MEAT & LIVESTOCK AUSTRALIA LIMITED, North Sydney, New South Wales (AU)

(21) Appl. No.: 15/528,795

(22) PCT Filed: Nov. 24, 2015
(86) PCT No.: PCT/GB2015/053586

§ 371 Date: May 23, 2017

(30) Foreign Application Priority Data
Nov. 24, 2014 (GB) 1420805.2

(51) Int. Cl. A61D 1/06; A61D 7/00; A61D 1/02

(52) U.S. Cl. CPC A61D 1/06; A61D 1/025; A61D 7/00

(57) ABSTRACT

An apparatus for removal of an animal body part, the apparatus comprising a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and a substance applicator, the substance applicator being configured to deliver a substance to the animal.

### FIELD OF THE INVENTION

This invention relates to the use of ligatures in the removal of animal body parts. The invention also relates to an apparatus for such use and a method of using the apparatus. In addition, the invention relates to an apparatus and the use thereof to restrict blood flow in animals.

The invention will be described with particular reference to the castration of lambs, but the principles of the invention can equally be employed in the castration of other animals and in the removal of other body parts such as tail docking and de-horning.

### BACKGROUND TO THE INVENTION

It is common practice to castrate male lambs at an early age for purposes including the prevention of undesired breeding and improved meat production. By far the most common method of doing so is by the application of a rubber ring to the scrotum above the testicles, which restricts the blood supply and leads to the atrophy and eventual dropping-off the scrotum and testicles. A tool is used to apply the rubber rings, usually in the form of a pliers-like instrument having four posts which locate within and spread the ring.

This procedure causes some concern on animal welfare grounds. The behaviour of lambs during the procedure indicates that there is a degree of pain which typically lasts some hours.

V. Molony et al, “Pain in lambs castrated at 2 days using novel smaller and tighter rubber rings without and with local anaesthetic”, Veterinary Journal (London, England) 2012; 193(1):81-6, describes an experiment in which rubber rings of smaller than usual size and of a different shape were used. The hypothesis was that the application of a higher degree of compression would produce loss of sensation by direct compression of the nerves. However, this proved not to be the case, and this was attributed to the presence of scrotal skin folds and wool preventing suitable compression of the nerves being achieved.

This paper also describes the use of local anaesthetic in one group of lambs in conjunction with the ring application. However, this was done as a separate operation using a needle-less injector. Such a procedure is unsuitable for commercial use where the operation is effected in very poor conditions in the field by farmers and shepherds. Moreover, the operator is normally working alone and has to restrain the lamb while carrying out the procedure; it is therefore desirable in practical terms to effect the castration procedure with one hand, leaving the other hand free for use in restraining the lamb.

### SUMMARY OF THE INVENTION

According to a first aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a substance applicator, the substance applicator being configured to deliver a substance to the animal.

The substance may be selected from one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements and validation markers. The substance may be a mixture or combination of one or more of the above-mentioned substances.

The substance applicator may be an anaesthetic applicator, an analgesic applicator, a medicine applicator, a medicinal product applicator, a vaccine applicator, an anthelmintic applicator, a nutrient applicator, a micronutrient applicator, a mineral applicator, a vitamin applicator, a growth promotant applicator, a tracer material applicator, an animal identification material applicator, a prophylactic applicator, an additive applicator, an insect control applicator, a bioactive applicator, a trace element applicator or a validation marker applicator. The substance applicator may be a combination of one or more of these applicators. That is, the substance applicator may be one or more of these applicators such that it performs one or more functions.

The substance may be an anaesthetic and/or an analgesic. The substance may be a vaccine. The substance may be a mixture of an anaesthetic and/or an analgesic and a vaccine.

The substance may be in the form of a fluid, a gel, a powder, a cream, or the like.

The ligature may be a closed elastic ligature capable of being applied in a stretched condition.

The ligature may be an elastic ligature. The ligature may be made from an elastic material.

The ligature may be a ring. The ligature may be an elastic ring.

The ligature applicator may be configured to engage with and move the ligature from an initial, retracted state to the first, extended state. This may be done before the ligature applicator moves to the second, retracted state.

The ligature applicator may include at least two members, the at least two members being movable relative to one another. The at least two members may be configured to move between a first position in which a retracted ligature may be applied to the ligature applicator, and a second position in which the ligature is in the extended state.

The ligature applicator may include three members, the three members being moveable relative to one another. The ligature applicator may include three or more members, the three or more members being moveable relative to one another. The ligature applicator may include four or five members, the four or five members being moveable relative to one another.

The members of the ligature applicator may be protrusions. The members of the ligature applicator may be pin members, protruding pins, or the like. One or more of the members of the ligature applicator may be moveable between a first position in which a ligature may be held in an extended state and a second position in which the ligature may be allowed to disengage from the members.

The apparatus may be a hand tool. The hand tool may comprise one or more handle portions. The hand tool may comprise two handle portions, the two handle portions being pivotably connected to one another. The hand tool may be configured such that movement of the two handle portions operates the ligature applicator. Movement of the two handle portions may operate the ligature applicator to move the ligature between the first, extended state and the second, retracted state. Movement of the two handle portions may move the members of the ligature applicator between the first and second positions.

The substance applicator may be configured to apply a substance to the animal body part. The substance applicator may be configured to deliver a substance to the animal body part around the selected application position of the ligature. The substance applicator may be configured to deliver a substance to the animal body part on either side of the ligature.

The substance applicator may be configured to move between a first, retracted position in which the substance applicator is remote from the animal body part, and a second, engaged position in which the substance applicator is engaged with the animal body part to deliver a substance to the animal body part.

The substance applicator may be configured to move between a first, retracted position in which the substance applicator is remote from the animal, and a second, position in which the substance applicator is in close proximity with the animal to deliver a substance to the animal.

The substance applicator may be configured to move between a first, retracted position in which the substance applicator is remote from the animal body part, and a second, engaged position in which the substance applicator is in close proximity with the animal body part to deliver a substance to the animal body part.

The substance applicator may include a motor, the motor being configured to move the substance applicator between the first and second positions. The motor may be an electric motor or a pneumatic motor.

The substance applicator may be configured to inject a substance to the animal.

The substance applicator may be configured to spray the substance on or towards the animal.

The substance applicator may be biased towards the first, retracted position.

The substance applicator may be configured to automatically return to the first, retracted position after movement to the second, engaged position. The substance applicator may be configured to automatically return to the first, retracted position after movement to the second, position.

The apparatus may further comprise a source of a substance to be delivered to the animal. The source of a substance to be delivered to the animal may be located with the apparatus, or alternatively located remotely from the apparatus. The source of a substance to be delivered to the animal may be a reservoir chamber, or the like. Where the source of a substance to be delivered to the animal is located remotely from the substance applicator, the source of a substance to be delivered to the animal is connected to the substance applicator by a conduit, such as a tube, or the like.

The substance applicator may be configured to receive a substance from the source of a substance to be delivered to the animal.

The substance applicator may comprise one or more needles, for example a hypodermic needle, or alternatively microneedles.

The one or more needles or microneedles may be moveable between the first and second positions to deliver the substance to the animal.

The substance applicator may be a needle-less applicator. In this arrangement the substance applicator may deliver the substance by a high-pressure injection technique or a high-pressure jet delivery.

The substance applicator may be adjustable relative to the apparatus. Where the substance applicator comprises one or more needles, the adjustment of the substance applicator allows the one or more needles to penetrate the animal at a different depth, the depth being dependent upon the adjustment of the substance applicator relative to the apparatus.

The apparatus may be configured such that the ligature applicator and the substance applicator can apply the ligature and the substance substantially simultaneously. Alternatively, the operation of the ligature applicator may occur before the operation of the substance applicator. Alternatively, the operation of the substance applicator may occur before the operation of the ligature applicator.

The apparatus may comprise two or more substance applicators. The apparatus may comprise two substance applicators.

Each substance applicator may be configured to apply a substance to the animal body part. Each substance applicator may be configured to deliver a substance to the animal body part around the selected application position of the ligature. Each substance applicator may be configured to deliver a substance to the animal body part on either side of the ligature. Each substance applicator may be configured to deliver a different substance to the animal body part.

Each substance applicator may be configured to move between a first, retracted position in which the substance applicator is remote from the animal body part, and a second, engaged position in which the substance applicator is engaged with the animal body part to deliver a substance to the animal body part.

Each substance applicator may be configured to move between a first, retracted position in which the substance applicator is remote from the animal, and a second, position in which the substance applicator is in close proximity with the animal to deliver a substance to the animal.

Each substance applicator may be configured to move between a first, retracted position in which the substance applicator is remote from the animal body part, and a second, engaged position in which the substance applicator is in close proximity with the animal body part to deliver a substance to the animal body part.

Each substance applicator may be configured to move independently between the first, retracted position and the second, engaged position. Alternatively, each substance applicator may be configured to move simultaneously between the first, retracted position and the second, engaged position.

Each substance applicator may include a motor, the motor being configured to move the substance applicator between the first and second positions. The motor may be an electric motor or a pneumatic motor.

Each substance applicator may be configured to inject a substance to the animal. Each substance applicator may include a needle for delivery of a substance to the animal.

Each substance applicator may be configured to spray the substance on or towards the animal.

Each substance applicator may be biased towards the first, retracted position.

Each substance applicator may be configured to automatically return to the first, retracted position after movement to the second, engaged position. Each substance applicator may be configured to automatically return to the first, retracted position after movement to the second, position.

The apparatus may further comprise two or more sources of a substance to be delivered to the animal. Each source of a substance to be delivered to the animal may be associated with a respective substance applicator. Alternatively, each source of a substance to be delivered to the animal body may be associated with a single substance applicator. Each source of a substance to be delivered to the animal may be located with the apparatus, or alternatively located remotely from the apparatus. Each source of a substance to be delivered to the animal may be a reservoir chamber, or the like. Where each source of a substance to be delivered to the animal is located remotely from the substance applicator, each source of a substance to be delivered to the animal is connected to the substance applicator by a conduit, such as a tube, or the like.

The substance applicator may be configured to receive a substance from each source of a substance to be delivered to the animal. Alternatively, each substance applicator may be configured to receive a substance from a respective source of a substance to be delivered to the animal.

Each substance applicator may comprise one or more needles, for example a hypodermic needle, or alternatively microneedles.

The one or more needles or microneedles may be moveable between the first and second positions to deliver the substance to the animal.

Each substance applicator may be a needle-less applicator. In this arrangement each substance applicator may deliver the substance by a high-pressure injection technique or a high-pressure jet delivery.

Each substance applicator may be adjustable relative to the apparatus. Where each substance applicator comprises one or more needles, the adjustment of each substance applicator allows the one or more needles to penetrate the animal at a different depth, the depth being dependent upon the adjustment of the substance applicator relative to the apparatus.

The apparatus may be configured such that the ligature applicator and each substance applicator can apply the ligature and the substance substantially simultaneously. Alternatively, the operation of the ligature applicator may occur before the operation of each substance applicator. Alternatively, the operation of each substance applicator may occur before the operation of the ligature applicator.

According to a second aspect of the present invention there is provided a method of removing an animal body part comprising the steps of:
providing an apparatus comprising:
   a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
   a substance applicator, the substance applicator being configured to deliver a substance to the animal;
providing a ligature to the ligature applicator;
operating the ligature applicator to move the ligature to the first, extended state;
locating the animal body part to be removed within the ligature;
operating the ligature applicator to move the ligature to the second, retracted state; and
operating the substance applicator to deliver a substance to the animal.

According to a third aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
an anaesthetic and/or analgesic applicator, the anaesthetic and/or analgesic applicator being configured to deliver an anaesthetic and/or analgesic to the animal.

The ligature may be a closed elastic ligature capable of being applied in a stretched condition.

The ligature may be an elastic ligature. The ligature may be made from an elastic material.

The ligature may be a ring. The ligature may be an elastic ring.

The ligature applicator may be configured to engage with and move the ligature from an initial, retracted state to the first, extended state. This may be done before the ligature applicator moves to the second, retracted state.

The ligature applicator may include at least two members, the at least two members being movable relative to one another. The at least two members may be configured to move between a first position in which a retracted ligature may be applied to the ligature applicator, and a second position in which the ligature is in the extended state.

The ligature applicator may include three members, the three members being moveable relative to one another. The ligature applicator may include three or more members, the three or more members being moveable relative to one another. The ligature applicator may include four or five members, the four or five members being moveable relative to one another.

The members of the ligature applicator may be protrusions. The members of the ligature applicator may be pin members, protruding pins, or the like. One or more of the members of the ligature applicator may be moveable between a first position in which a ligature may be held in an extended state and a second position in which the ligature may be allowed to disengage from the members.

The apparatus may be a hand tool. The hand tool may comprise one or more handle portions. The hand tool may comprise two handle portions, the two handle portions being pivotably connected to one another. The hand tool may be configured such that movement of the two handle portions operates the ligature applicator. Movement of the two handle portions may operate the ligature applicator to move the ligature between the first, extended state and the second, retracted state. Movement of the two handle portions may move the members of the ligature applicator between the first and second positions.

The anaesthetic and/or analgesic applicator may be configured to apply an anaesthetic and/or analgesic to the animal body part. The anaesthetic and/or analgesic applicator may be configured to deliver an anaesthetic and/or analgesic to the animal body part around the selected application position of the ligature. The anaesthetic and/or analgesic applicator may be configured to deliver an anaesthetic and/or analgesic to the animal body part on either side of the ligature.

The anaesthetic and/or analgesic applicator may be configured to move between a first, retracted position in which the anaesthetic and/or analgesic applicator is remote from the animal body part, and a second, engaged position in which the anaesthetic and/or analgesic applicator is engaged with the animal body part to deliver anaesthetic and/or analgesic to the animal body part.

The anaesthetic and/or analgesic applicator may be configured to inject anaesthetic and/or analgesic to the animal.

The anaesthetic and/or analgesic applicator may be biased towards the first, retracted position.

The anaesthetic and/or analgesic applicator may be configured to automatically return to the first, retracted position after movement to the second, engaged position.

The apparatus may further comprise a source of anaesthetic and/or analgesic. The source of anaesthetic and/or analgesic may be located with the apparatus, or alternatively located remotely from the apparatus. The source of anaesthetic and/or analgesic may be a reservoir chamber, or the like. Where the source of anaesthetic and/or analgesic is located remotely from the anaesthetic and/or analgesic applicator, the source of anaesthetic and/or analgesic is connected to the anaesthetic and/or analgesic applicator by a conduit, such as a tube, or the like.

The anaesthetic and/or analgesic applicator may be configured to receive anaesthetic and/or analgesic from the source of anaesthetic and/or analgesic. The apparatus may further comprise a source of a substance to be delivered to the animal. The substance may be selected from one or more of the group consisting of: medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements and validation markers. The substance may be a mixture or combination of one or more of the above-mentioned substances. The apparatus may be configured to deliver both the anaesthetic and/or analgesic and the substance to the animal through the anaesthetic and/or analgesic applicator. In this arrangement the anaesthetic and/or analgesic and the substance may originate from separate sources, but are delivered to the animal simultaneously.

The anaesthetic and/or analgesic applicator may comprise one or more needles, for example a hypodermic needle, or alternatively microneedles.

The one or more needles or microneedles may be moveable between the first and second positions to deliver anaesthetic and/or analgesic to the animal.

The anaesthetic and/or analgesic applicator may be a needle-less applicator. In this arrangement the anaesthetic and/or analgesic applicator may deliver the anaesthetic and/or analgesic by a high-pressure injection technique or a high-pressure jet delivery.

The anaesthetic and/or analgesic applicator may be adjustable relative to the apparatus. Where the anaesthetic and/or analgesic applicator comprises one or more needles, the adjustment of the anaesthetic and/or analgesic applicator allows the one or more needles to penetrate the animal at a different depth, the depth being dependent upon the adjustment of the aesthetic and/or analgesic applicator relative to the apparatus.

The apparatus may be configured such that the ligature applicator and the anaesthetic and/or analgesic applicator can apply the ligature and the anaesthetic and/or analgesic substantially simultaneously. Alternatively, the operation of the ligature applicator may occur before the operation of the substance applicator. Alternatively, the operation of the substance applicator may occur before the operation of the ligature applicator.

The apparatus may further comprise a further substance applicator, the further substance applicator being configured to deliver a substance to the animal.

The substance may be selected from one or more of the group consisting of: medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements and validation markers. The substance may be a mixture or combination of one or more of the above-mentioned substances.

The further substance applicator may be a medicine applicator, a medicinal product applicator, a vaccine applicator, an anthelmintic applicator, a nutrient applicator, a micronutrient applicator, a mineral applicator, a vitamin applicator, a growth promotant applicator, a tracer material applicator, an animal identification material applicator, a prophylactic applicator, an additive applicator, an insect control applicator, a bioactive applicator, a trace element applicator or a validation marker applicator.

The substance may be a vaccine.

The substance may be in the form of a fluid, a gel, a powder, a cream, or the like.

The further substance applicator may be configured to apply the substance to the animal body part. The further substance applicator may be configured to deliver the substance to the animal body part around the selected application position of the ligature. The further substance applicator may be configured to deliver the substance to the animal body part on either side of the ligature.

The further substance applicator may be configured to move between a first, retracted position in which the further substance applicator is remote from the animal body part, and a second, engaged position in which the further substance applicator is engaged with the animal body part to deliver the substance to the animal body part.

The further substance applicator may be configured to move between a first, retracted position in which the further substance applicator is remote from the animal, and a second, position in which the further substance applicator is in close proximity with the animal to deliver the substance to the animal.

The further substance applicator may be configured to move between a first, retracted position in which the further substance applicator is remote from the animal body part, and a second, engaged position in which the further substance applicator is in close proximity with the animal body part to deliver the substance to the animal body part.

The further substance applicator may be configured to inject the substance to the animal.

The further substance applicator may be biased towards the first, retracted position.

The further substance applicator may be configured to automatically return to the first, retracted position after movement to the second, engaged position. The further substance applicator may be configured to automatically return to the first, retracted position after movement to the second, position.

The apparatus may further comprise a source of the substance to be delivered to the animal. The source of the substance to be delivered to the animal may be located with the apparatus, or alternatively located remotely from the apparatus. The source of the substance to be delivered to the animal may be a reservoir chamber, or the like. Where the source of the substance to be delivered to the animal is located remotely from the substance applicator, the source of the substance to be delivered to the animal is connected to the substance applicator by a conduit, such as a tube, or the like.

The further substance applicator may be configured to receive the substance from the source of a substance to be delivered to the animal.

The further substance applicator may comprise one or more needles, for example a hypodermic needle, or alternatively microneedles.

The one or more needles or microneedles may be moveable between the first and second positions to deliver the substance to the animal.

The further substance applicator may be a needle-less applicator. In this arrangement the further substance applicator may deliver the substance by a high-pressure injection technique or a high-pressure jet delivery.

The further substance applicator may be adjustable relative to the apparatus. Where the further substance applicator comprises one or more needles, the adjustment of the further substance applicator allows the one or more needles to penetrate the animal at a different depth, the depth being dependent upon the adjustment of the further substance applicator relative to the apparatus.

The anaesthetic and/or analgesic applicator and the further substance applicator may be configured to move independently between the first, retracted position and the second, engaged position. Alternatively, the anaesthetic and/or analgesic applicator and the further substance applicator may be configured to move simultaneously between the first, retracted position and the second, engaged position.

The apparatus may further comprise a source of anaesthetic and/or analgesic to be delivered to the animal and a source of a substance to the delivered to the animal. Each source may be associated with a respective applicator. Alternatively, each source may be associated with a single applicator. That is, the apparatus may be configured to deliver an anaesthetic and/or analgesic and a substance to the animal. Each source may be located with the apparatus, or alternatively located remotely from the apparatus. Each source may be a reservoir chamber, or the like. Where each source is located remotely from the applicator, each source is connected to the applicator by a conduit, such as a tube, or the like.

The apparatus may be configured such that the ligature applicator and each applicator can apply the ligature and the anaesthetic and/or analgesic and substance substantially simultaneously. Alternatively, the operation of the ligature applicator may occur before the operation of each applicator. Alternatively, the operation of each applicator may occur before the operation of the ligature applicator.

According to a fourth aspect of the present invention there is provided a method of removing an animal body part comprising the steps of:
providing an apparatus comprising:
   a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
   an anaesthetic and/or analgesic applicator, the anaesthetic and/or analgesic applicator being configured to deliver an anaesthetic and/or analgesic to the animal;
providing a ligature to the ligature applicator;
operating the ligature applicator to move the ligature to the first, extended state;
locating the animal body part to be removed within the ligature;
operating the ligature applicator to move the ligature to the second, retracted state; and
operating the anaesthetic and/or analgesic applicator to deliver an anaesthetic and/or analgesic to the animal.

According to a fifth aspect of the present invention there is provided a device for removal of an animal body part, comprising a ligature capable of being moved between a first, extended state in which it can be passed over the body part to a selected application position and a second, retracted state in which it applies a compressive force at said location sufficient to restrict blood flow, and an anaesthetic and/or analgesic applicator associated with the ligature for applying an anaesthetic and/or analgesic to the body part at the time of applying the ligature.

Thus, pain relief can be accomplished at the same time as ligation, in a simple operation suited to field use.

In certain embodiments, the ligature is a closed elastic ligature, optionally a ring, capable of being applied in a stretched condition.

In other embodiments the ligature is a strap or cord, and the device includes a one-way restraining device through which the ligature passes. The strap or cord is optionally of an elastic material.

In another embodiment, the ligature is in the form of a clip having two parts movable with respect to each other and resilient means biasing the two parts to a closed position.

The anaesthetic and/or analgesic applicator optionally comprises one or more needles, for example a hypodermic needle, or alternatively microneedles.

Optionally also the anaesthetic and/or analgesic applicator comprises a reservoir for liquid anaesthetic and/or analgesic. The anaesthetic and/or analgesic reservoir may be formed in the body of the ligature, or may comprise a pouch or cartridge attached to the ligature.

According to a sixth aspect of the present invention there is provided an anaesthetic and/or analgesic applicator for use in removal of an animal body part by application of a restricting ligature, the applicator comprising a first portion adapted to engage with a ligature for mounting thereon and a second portion forming an anaesthetic and/or analgesic reservoir.

The anaesthetic and/or analgesic applicator may further comprise a needle movable with respect to the reservoir between an initial closed position in which fluid flow is prevented and an open position permitting fluid flow, said movement resulting from tightening of the ligature against a surface. The anaesthetic and/or analgesic applicator may further comprise a needle movable with respect to the reservoir between an initial closed position in which anaesthetic and/or analgesic flow is prevented and an open position permitting anaesthetic and/or analgesic flow, said movement resulting from tightening of the ligature against a surface.

According to a seventh aspect of the present invention there is provided a method of removing an animal body part, comprising applying a ligature to a selected location on the body part so as to apply a compressive force at said location sufficient to restrict blood flow, and applying an anaesthetic and/or analgesic to the body part at the time of applying the ligature from a reservoir associated with the ligature.

According to an eighth aspect of the present invention there is provided a device for restricting blood flow in an appendage of an animal, comprising a ligature capable of being moved between a first, extended state in which it can be passed over the body part to a selected application position and a second, retracted state in which it applies a compressive force at said location sufficient to restrict blood flow, and an anaesthetic and/or analgesic applicator associated with the ligature for applying an anaesthetic and/or analgesic to the body part at the time of applying the ligature.

According to a ninth aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
an anaesthetic applicator, the anaesthetic applicator being configured to deliver an anaesthetic to the animal.

According to an tenth aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
an analgesic applicator, the analgesic applicator being configured to deliver an analgesic to the animal.

According to a eleventh aspect of the present invention there is provided a method of removing an animal body part comprising the steps of:
providing an apparatus comprising:
   a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
   an anaesthetic applicator, the anaesthetic applicator being configured to deliver an anaesthetic to the animal;
providing a ligature to the ligature applicator;
operating the ligature applicator to move the ligature to the first, extended state;
locating the animal body part to be removed within the ligature;
operating the ligature applicator to move the ligature to the second, retracted state; and
operating the anaesthetic applicator to deliver an anaesthetic to the animal.

According to a twelfth aspect of the present invention there is provided a method of removing an animal body part comprising the steps of:
providing an apparatus comprising:
   a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
   an analgesic applicator, the analgesic applicator being configured to deliver an analgesic to the animal;
providing a ligature to the ligature applicator;
operating the ligature applicator to move the ligature to the first, extended state;
locating the animal body part to be removed within the ligature;
operating the ligature applicator to move the ligature to the second, retracted state; and
operating the analgesic applicator to deliver an analgesic to the animal.

According to an thirteenth aspect of the present invention there is provided a device for removal of an animal body part, comprising a ligature capable of being moved between a first, extended state in which it can be passed over the body part to a selected application position and a second, retracted state in which it applies a compressive force at said location sufficient to restrict blood flow, and an anaesthetic applicator associated with the ligature for applying an anaesthetic to the body part at the time of applying the ligature.

According to a fourteenth aspect of the present invention there is provided a device for removal of an animal body part, comprising a ligature capable of being moved between a first, extended state in which it can be passed over the body part to a selected application position and a second, retracted state in which it applies a compressive force at said location sufficient to restrict blood flow, and an analgesic applicator associated with the ligature for applying an analgesic to the body part at the time of applying the ligature.

According to a fifteenth aspect of the present invention there is provided an anaesthetic applicator for use in removal of an animal body part by application of a restricting ligature, the applicator comprising a first portion adapted to engage with a ligature for mounting thereon and a second portion forming an anaesthetic reservoir.

According to a sixteenth aspect of the present invention there is provided an analgesic applicator for use in removal of an animal body part by application of a restricting ligature, the applicator comprising a first portion adapted to engage with a ligature for mounting thereon and a second portion forming an analgesic reservoir.

According to a seventeenth aspect of the present invention there is provided a method of removing an animal body part, comprising applying a ligature to a selected location on the body part so as to apply a compressive force at said location sufficient to restrict blood flow, and applying an anaesthetic to the body part at the time of applying the ligature from a reservoir associated with the ligature.

According to a eighteenth aspect of the present invention there is provided a method of removing an animal body part, comprising applying a ligature to a selected location on the body part so as to apply a compressive force at said location sufficient to restrict blood flow, and applying an analgesic to the body part at the time of applying the ligature from a reservoir associated with the ligature.

According to a nineteenth aspect of the present invention there is provided a device for restricting blood flow in an appendage of an animal, comprising a ligature capable of being moved between a first, extended state in which it can be passed over the body part to a selected application position and a second, retracted state in which it applies a compressive force at said location sufficient to restrict blood flow, and an anaesthetic applicator associated with the ligature for applying an anaesthetic to the body part at the time of applying the ligature.

According to an twentieth aspect of the present invention there is provided a device for restricting blood flow in an appendage of an animal, comprising a ligature capable of being moved between a first, extended state in which it can be passed over the body part to a selected application position and a second, retracted state in which it applies a compressive force at said location sufficient to restrict blood flow, and an analgesic applicator associated with the ligature for applying an analgesic to the body part at the time of applying the ligature.

According to a twenty-first aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a medicinal applicator, the medicinal applicator being configured to deliver a medicinal product to the animal.

According to a twenty-second aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a substance delivery system, the substance delivery system being configured to deliver a substance to the animal.

According to a twenty-third aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a drug or pharmaceutical delivery system, the drug or pharmaceutical delivery system being configured to deliver a drug or pharmaceutical to the animal.

According to a twenty-fourth aspect of the present invention there is provided an apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a substance applicator, the substance applicator being configured to deliver two or more substances to the animal.

The two or more substances may include an anaesthetic and/or an analgesic. The two or more substances may include an anaesthetic and/or an analgesic in combination with one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements, validation markers

According to a twenty-fifth aspect of the present invention there is provided a device for removal of an animal body part, comprising a ligature capable of being moved between a first, extended state in which it can be passed over the body part to a selected application position and a second, retracted state in which it applies a compressive force at said location sufficient to restrict blood flow, and a substance applicator associated with the ligature for applying a substance to the body part at the time of applying the ligature.

According to a twenty-sixth aspect of the present invention there is provided a substance applicator for use in removal of an animal body part by application of a restricting ligature, the applicator comprising a first portion adapted to engage with a ligature for mounting thereon and a second portion forming a substance reservoir.

According to a twenty-seventh aspect of the present invention there is provided a method of removing an animal body part, comprising applying a ligature to a selected location on the body part so as to apply a compressive force at said location sufficient to restrict blood flow, and applying a substance to the body part at the time of applying the ligature from a reservoir associated with the ligature.

According to a twenty-eighth aspect of the present invention there is provided a device for restricting blood flow in an appendage of an animal, comprising a ligature capable of being moved between a first, extended state in which it can be passed over the body part to a selected application position and a second, retracted state in which it applies a compressive force at said location sufficient to restrict blood flow, and a substance applicator associated with the ligature for applying a substance to the body part at the time of applying the ligature.

The alternative features and different embodiments as described apply to each and every aspect and each and every embodiment thereof mutatis mutandis.

### BRIEF DESCRIPTION OF THE DRAWINGS

Embodiments of the invention will now be described, by way of example, with reference to the drawings, in which:

FIGS. 1a-1d are sequential perspective views of one embodiment of the invention in use;

FIGS. 2a-2c show a modified form of the invention of FIG. 1;

FIG. 3 is a plan view of an alternative to a rubber/latex ring;

FIG. 4 is a cross-sectional side view of another embodiment in the form of a saddle for attachment to a standard ring;

FIG. 5 is a cross-section of a further embodiment;

FIGS. 6a-6d are sequential perspective views of another embodiment of the invention in use;

FIG. 7a is a partial perspective view of yet another embodiment;

FIGS. 7b and 7c are cross-sectional front views of part of the device of FIG. 7a and illustrating its operation;

FIG. 8 shows a modified form of the embodiment of FIG. 7a;

FIG. 9 is a schematic illustration of a further embodiment;

FIGS. 10a-10d illustrate a further embodiment;

FIGS. 11a and 11b show an embodiment similar to that of FIGS. 10a-10d;

FIGS. 12a and 12b show a further embodiment;

FIG. 13 is a cross-sectional view of a further embodiment;

FIGS. 14a to 14d are sequential perspective views of a further embodiment in various states of use; and

FIG. 15 is a side view of a further embodiment.

### DESCRIPTION OF EMBODIMENTS

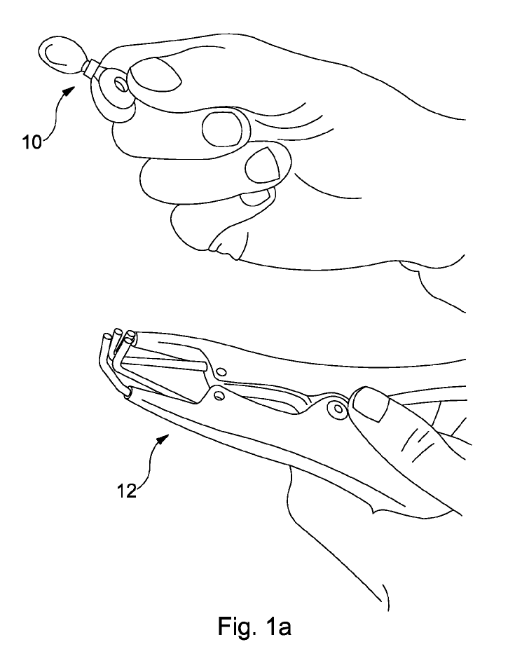

Referring to FIG. 1a, in a first embodiment a castration device generally designated at 10 is applied by means of an applicator tool 12. The device 10, as best seen in FIG. 1b, comprises a rubber/latex ring 14 (an example of a ligature) on which is mounted an injector assembly (an example of an anaesthetic and/or analgesic applicator or a substance applicator) comprising a hypodermic needle 16 communicating with a resilient bladder 18 containing a liquid anaesthetic and/or an analgesic (an example of a substance). The needle 16 passes through and is secured in a rubber boss 20 moulded integrally with, or bonded to, the ring 14.

In the embodiments illustrated and described here the castration device 10 is described as being used with an anaesthetic and/or analgesic, it should be appreciated that the castration device 10 of the present invention may be used with a number of substances. For example, the substance may be selected from one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements and validation markers. The anaesthetic and/or analgesic may also be delivered in combination with any of the substances listed above.

The anaesthetic composition may suitably be a synthetic cocaine derivative such as Novocaine or Lignocaine in aqueous solution. The anaesthetic composition may suitably be Procaine, Lidocaine or Bupivacaine. The anaesthetic composition may or may not be in an aqueous solution.

The composition may additionally include adrenaline to reduce bleeding. A volume of 1 to 4 ml is suitable for use with lambs.

As also seen in FIG. 1b, the applicator tool 12 has four posts 22 which engage and stretch the ring 14. Tools of this nature are well known and in common use with plain rubber rings. In use, the operator passes the stretched ring 14 over the scrotum (FIG. 1c) to a position above or proximally of the testicles (an example of a selected application position). The tool is then released to allow the ring to contract around the scrotum and the tool is removed. The operator can then (FIG. 1d) apply pressure to the bladder 18 to inject the anaesthetic and/or analgesic into the scrotum.

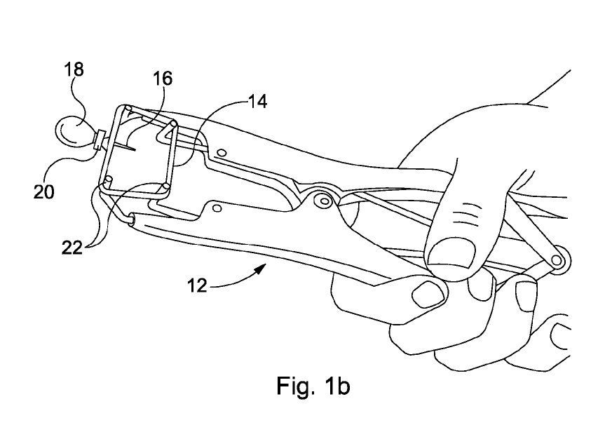

Turning to FIG. 2, FIG. 2a shows a castration device 10 in its pre-use condition, while FIG. 2b shows the device stretched and ready for application. The device 10 comprises a rubber ring 14 with an integrally moulded boss 20. A hypodermic needle 16 (an example of an anaesthetic and/or analgesic applicator or substance applicator) terminates within the boss 20 in the pre-use condition, and communicates with a reservoir 24 containing anaesthetic and/or analgesic.

FIG. 2b shows the device 10 stretched by the posts 22 of an applicator tool. The tool is modified to provide a back stop 26 such that, as the ring is stretched, the tip of the needle 16 is pushed through the boss 20 into the interior of the ring 14. Thus, a single one-handed action may be used.

The reservoir 24 may be made from two vacuum formed components 24a and 24b (FIG. 2c) which are bonded together as a sandwich with the needle 16 trapped between them. The needle 16 in this embodiment may be a standard hypodermic needle.

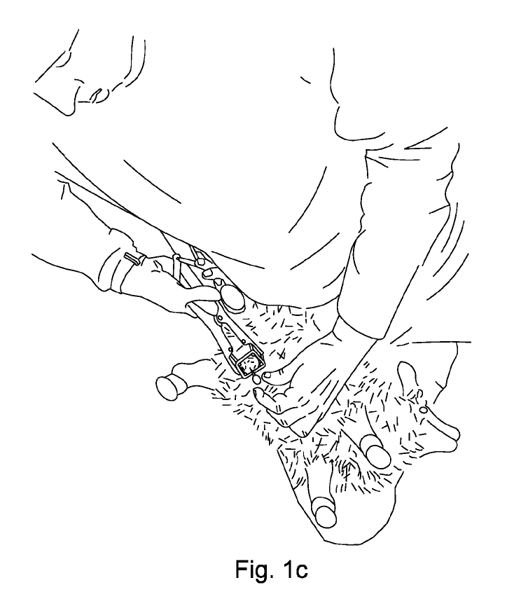

FIG. 3 shows a device 30 which is functionally equivalent to a ring, but is formed by cutting or punching from a sheet of resilient material such as latex. The device 30 has a central aperture 32 to surround the scrotum, and four holes 34 for engagement by the posts of an applicator tool. It may be necessary to provide the tool with ejector pins to push the device 30 off the posts.

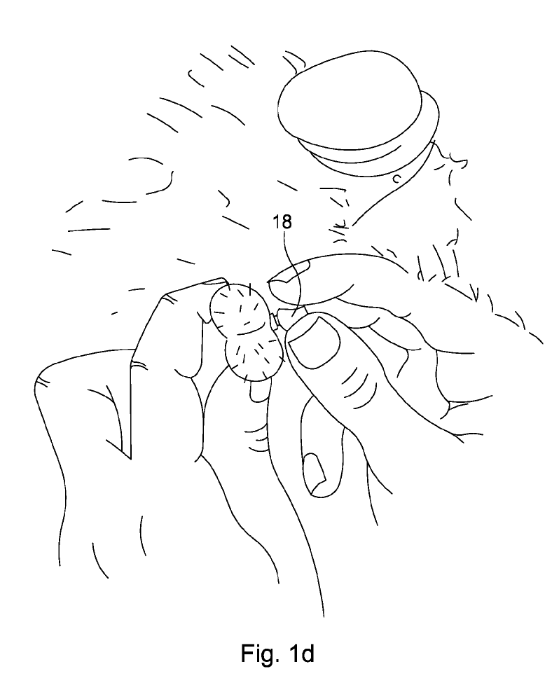

FIG. 4 shows an embodiment in which a standard rubber ring 40 and standard applicator tool may be used in conjunction with an anaesthetic and/or analgesic device 42 (an example of an apparatus for removal of an animal body part). The device 42 has a body 44 in the form of a saddle. A membrane 46 is attached to the body 44 to define an anaesthetic and/or analgesic reservoir 48. The opposite face of the body is formed with needles 49 communicating with the reservoir 48 (together an example of an anaesthetic and/or analgesic applicator). In this example, a number of microneedles are used, but a single hypodermic needle could be used.

In use, the ring 40 is stretched on the standard applicator tool, and the device 42 clips over it, as seen in FIG. 4. The combined assembly is then applied to the lamb in the normal way.

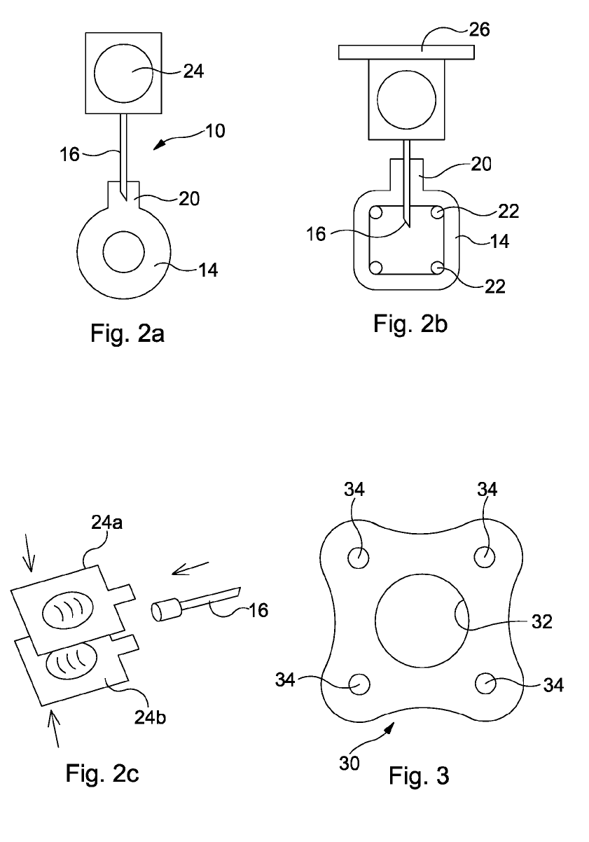

FIG. 5 shows a resilient ring 50 which is formed as a hollow ring providing an annular chamber 52 containing liquid anaesthetic and/or analgesic.

One or more hollow microneedles 54 on the inner periphery of the ring 50 communicate with the chamber 52. The ring can be applied in the usual way using a standard tool.

Microneedles are well known per se and are commonly used in dermal patches. Microneedles may be hollow, for use with liquids, or solid and coated with active substance. The present invention could be realised in the form of a ring having internally-facing solid microneedles, given a suitable anaesthetic and/or analgesic product for this purpose. It may also be possible to use an anaesthetic and/or analgesic on the ring, or dispersed within the ring, which diffuses through the skin without the use of microneedles.

An alternative to the use of needles, is the use of needle-less injectors as are known in the art. For example, the MicroJet™ injector developed at MIT. Other needle-less injectors are known and could also be used.

The foregoing embodiments all rely on the use of resilient rings. Other forms of the present invention make use of straps or cords which can be tightened by applying a tensioning force and locked in place.

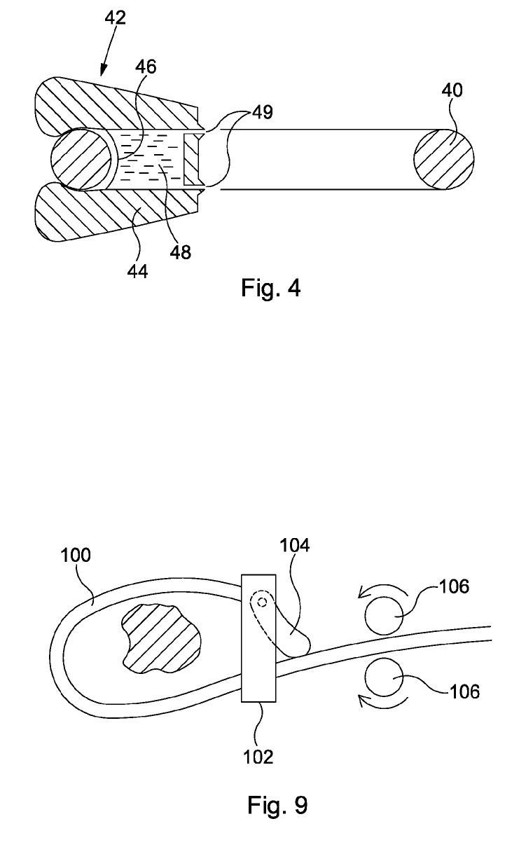

Referring to FIGS. 6a to 6d, a castration device 60 comprises a strap 62 forming a noose and passing through a one-way locking device 64. In use, the strap 62 is positioned over the scrotum proximally of the testicles (FIG. 6a). The strap is then pulled tight (FIG. 6b). An anaesthetic and/or analgesic cartridge 66 mounted on the locking device 64 is discharged, for example by twisting or squeezing, through a needle (not seen in the drawing) projecting inwardly from the locking device 64. The cartridge 66 is then removed and discarded.

The locking device 64 may be for example a cam cleat or jamming cleat operating on a plain strap, or may be a ratchet operating on a toothed strap.

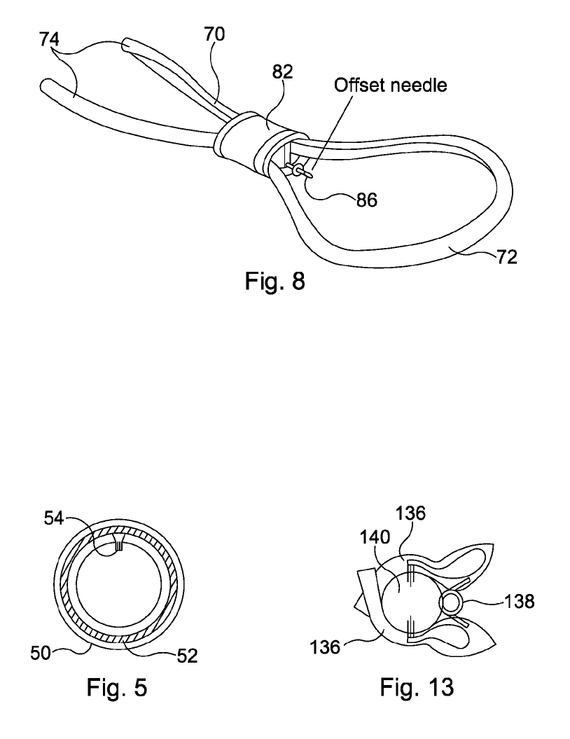

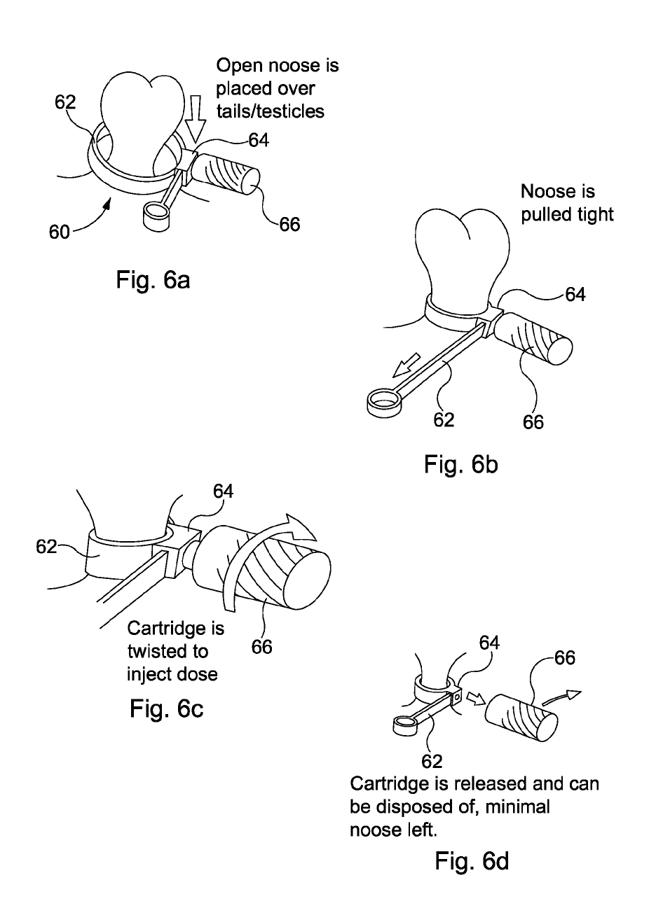

Referring to FIG. 7a, a castration device comprises a cord 70 formed into a noose 72 and free ends 74. The cord 70 passes a securing device 76 formed with two cord-retaining channels 78 and ratchet teeth 80 which together provide one-way tensioning.

The ratchet teeth 80 are formed on opposed faces of a central block 82 which also forms a reservoir 84 for liquid anaesthetic and/or analgesic. A needle 86 is biased outwardly from the reservoir by a spring 88 to a position limited by an internal flange 90 which also closes the bore of the needle 86. The protruding part of the needle 86 is provided with an annular washer or shoulder 92.

The needle 86 has a lateral opening 94 into the bore of the needle, which opening 94 is initially within the body of the device 76 (see FIG. 7b). When the device 70 is applied and tightened, the needle 86 contacts the scrotum and on further tightening is forced into the reservoir 84 (FIG. 7c), permitting the anaesthetic and/or analgesic liquid to flow through the needle 86 via the lateral opening 94.

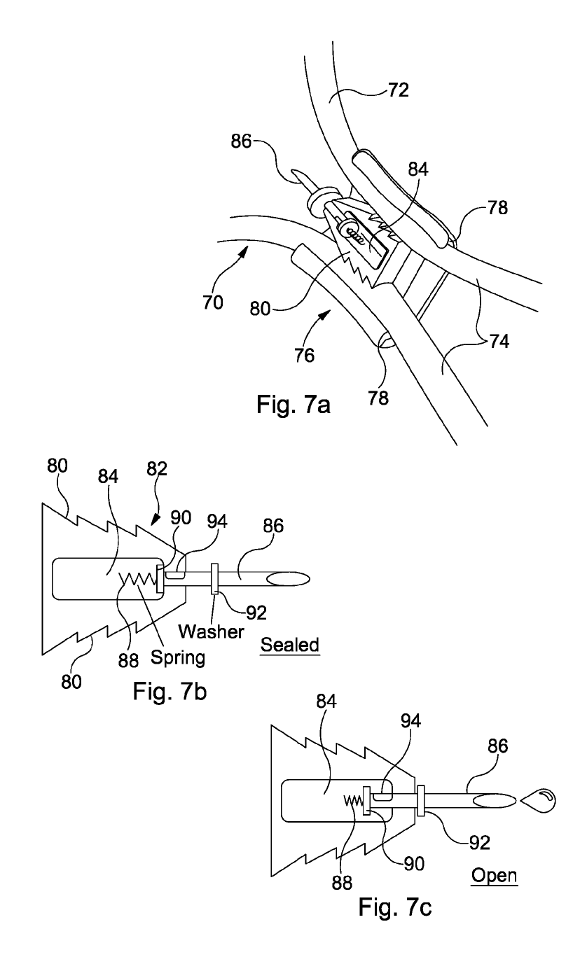

FIG. 8 shows a device similar to that of FIG. 7, but with the needle 86 offset relative to the path of the cord 70.

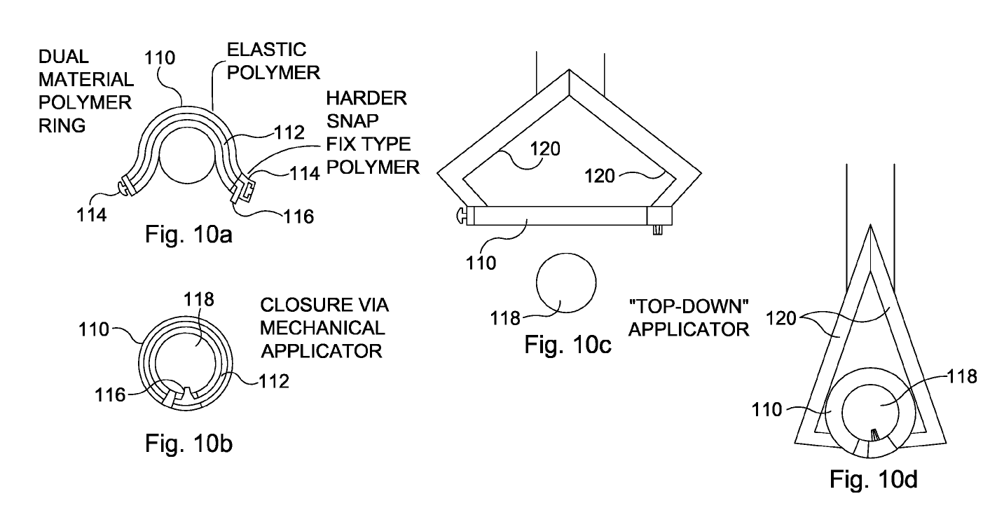

The foregoing embodiments using straps or cords rely on manual tightening which requires the operator to use two hands. It would be possible to use an applicator tool for single handed operation. For example, FIG. 9 shows an arrangement in which a rubber cord 100 is anchored at one end to a cleat body 102. The free end is passed through a cam 104 pivoted in the cleat body 102 forming a one-way cam, thus providing a noose in the cord. The cam body 102 is removably positioned in a tool (mostly not shown) which includes wheels or rollers 106 gripping the cord 100. The noose is placed in the appropriate position and the wheels 106 are rotated as shown to tighten the cord 100. The tool is then removed, leaving the cord and cleat in position. The wheels 106 may be rotated by an electric motor, or manually for example by a pistol grip acting through a ratchet mechanism.

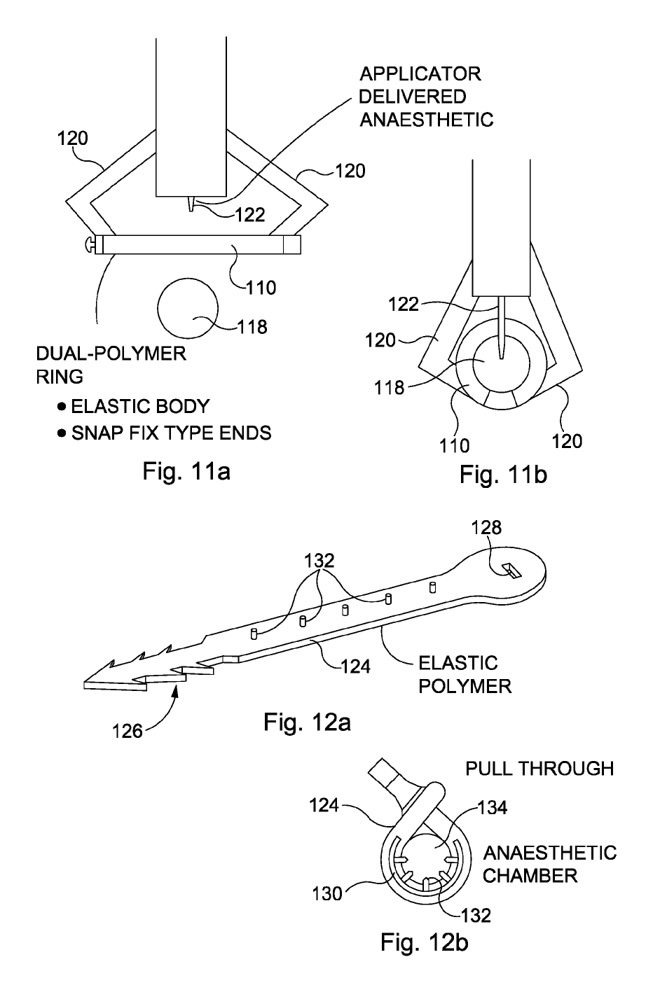

The embodiment shown in FIGS. 10a to 10d make use of a ligature in the form of a band 110 formed of an elastic polymer, with an internal reservoir 112 for liquid anaesthetic and/or analgesic. The ends of the band 110 are secured to elements 114 of a harder polymer which are provided with inter-fitting formations which can be snapped together. One of the elements 114 mounts a needle 116 communicating with the reservoir 112. The band 110 can be passed over a body part 118 as in FIG. 10a, and the ends pressed together to lock the elements 114, the same action causing the needle 116 to penetrate the body part 118 as in FIG. 10b.

FIGS. 10c and 10d show this operation being performed by use of an applicator (an example of a ligature applicator) having hinged arms 120 which is arranged to operate “top down”, as opposed to the conventional “on end” applicator.

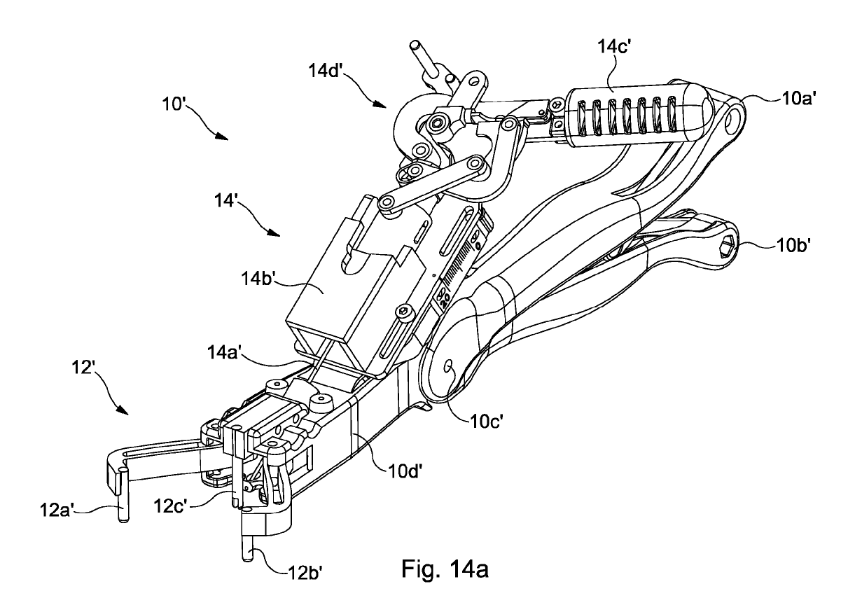

The embodiment of FIGS. 11a and 11b uses a similar snap-close band, like parts being denoted by like reference numerals. Here, however, the band does not have a reservoir and needle. Instead, the applicator (an example of a ligature applicator) is provided with a needle 122 (an example of an anaesthetic and/or analgesic applicator or a substance applicator) which is extended as the arms 120 close and injects a dose of anaesthetic and/or analgesic from a reservoir (not shown) within the applicator.

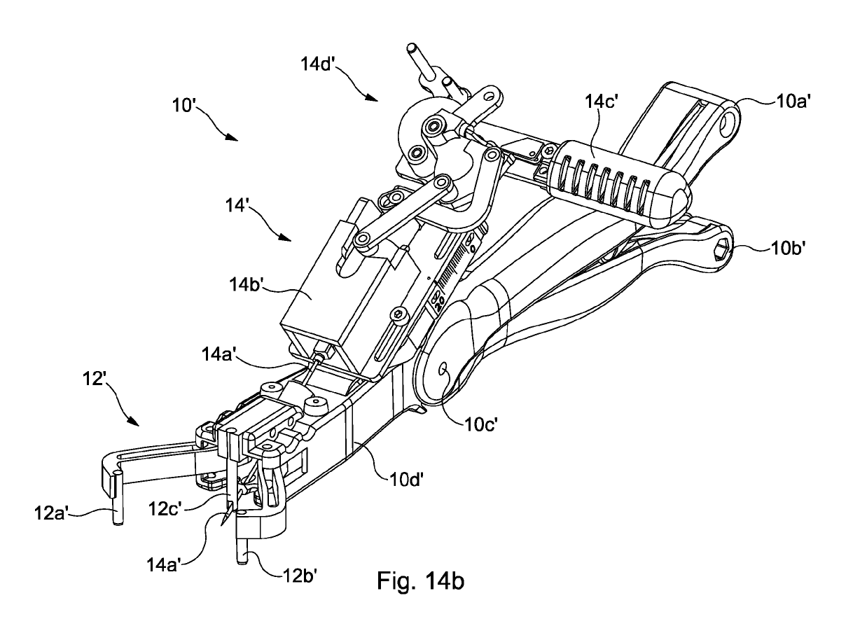

FIGS. 12a and 12b show an embodiment in the form of a strap 124 which is formed at one end with ratchet teeth 126, and at the other end with a slot 128 through which the first end can be passed and locked. A central portion of the strap 124 is formed with a reservoir 130 communicating with microneedles 132 passing exteriorly of the strap 124. FIG. 12a shows the device before use, and FIG. 12b after application to a body part 134.

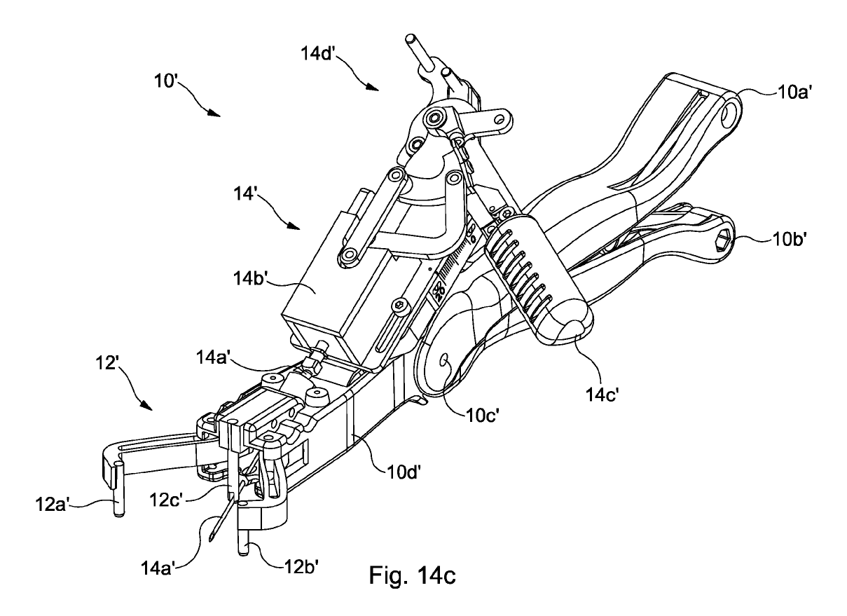

The embodiment of FIG. 13 provides a clip having two members 136 which are connected for relative pivotal movement and biased together by a coiled spring 138. It will be understood that the assembly can be opened, applied and released in the manner of a clothes peg to clamp the device around a body part 140 as shown.

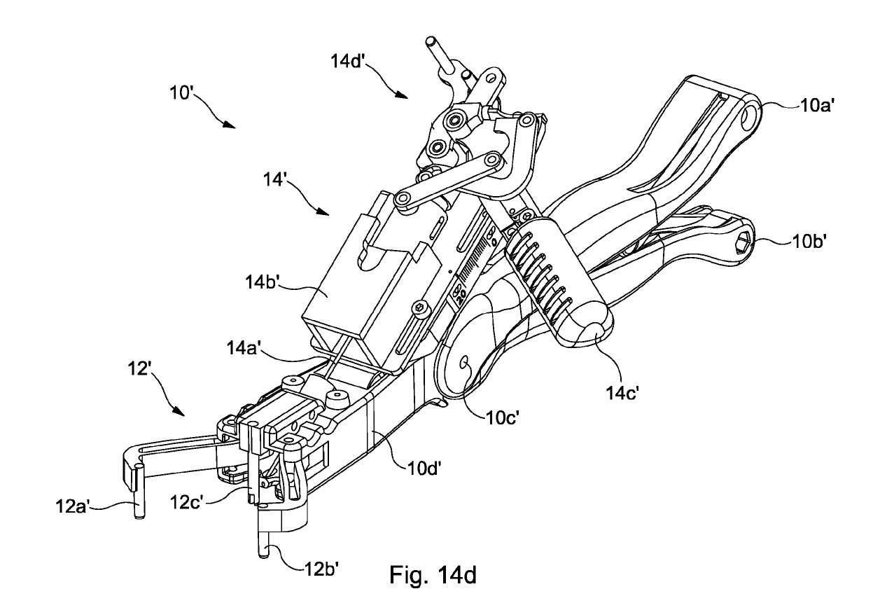

FIGS. 14a to 14d illustrate an apparatus 10′ for removal of an animal body part. The apparatus 10′ includes a ligature applicator 12′ and an anaesthetic and/or analgesic applicator 14′ (an example of a substance applicator). As described further below, the ligature applicator 12′ is configured to move a ligature (not illustrated) between a first, extended state in which the ligature can be passed over the animal body part (not illustrated) to a selected application position, and a second, retracted state in which the ligature applies a compressive force at the application position to restrict blood flow in the animal body part.

The apparatus 10′ is configured to operate with a rubber/latex ring, such as the ring 14 described above. The ligature may be a closed elastic ligature capable of being applied in a stretched condition.

In the embodiment illustrated and described here the ligature applicator 12′ comprises three pin members (examples of members) 12a′, 12b′, 12c′. The three pin members 12a′, 12b′, 12c′ are moveable relative to one another. The three pin members 12a′, 12b′, 12c′ are moved by operation of two handle portions 10a′, 10b′, as described below. The three pin members 12a′, 12b′, 12c′ of the ligature applicator 12′ are configured to engage with and move the ligature from an initial, retracted state to the first, extended state. As described further below, this may be done before the ligature applicator 12′ moves to the second, retracted state. The three pin members 12a′, 12b′, 12c′ are also moveable, or pivotable, between a first position in which a ligature may be held in an extended state and a second position in which the ligature may be allowed to disengage from the members. This assists in disengagement of the ligature from the three pin members 12a′, 12b′, 12c′.

As illustrated, the apparatus 10′ is in the form of a hand tool and includes two handle portions 10a′ 10b′ and a body portion 10d′. The handle portions 10a′, 10b′ are pivotably connected to one another about a pivot point 10c′. The ligature applicator 12′ and the anaesthetic and/or analgesic applicator 14′ are connected to the body portion 10d′.

The apparatus 10′ is configured such that movement of the two handle portions 10a′, 10b′ operates the ligature applicator 12′. As described below, movement of the two handle portions 10a′ 10b′ operates the ligature applicator 12′ to move the ligature between the first, extended state and the second, retracted state. Movement of the two handle portions 10a′, 10b′ results in movement of the ligature applicator 12′ between the first and second positions. In the embodiment illustrated and described here movement of the two handle portions 10a′, 10b′ results in movement pin members 12a′ and 12b′ relative to the handle portions 10a′, 10b′, pin member 12c′ being held in a fixed position. In this arrangement pin members 12a′ and 12b′ move away from pin member 12c′ when the handle portions 10a′, 10b′ are brought together.

The anaesthetic and/or analgesic applicator 14′ is configured to deliver an anaesthetic and/or analgesic to the animal body part. In the embodiment illustrated and described here the anaesthetic and/or analgesic applicator 14′ delivers an anaesthetic and/or analgesic to the animal. However, it should be appreciated that the applicator may be configured to deliver other substances to the animal. For example, the substance may be selected from one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements and validation markers. The applicator may therefore be an anaesthetic applicator, an analgesic applicator, a medicine applicator, a medicinal product applicator, a vaccine applicator, an anthelmintic applicator, a nutrient applicator, a micronutrient applicator, a mineral applicator, a vitamin applicator, a growth promotant applicator, a tracer material applicator, an animal identification material applicator, a prophylactic applicator, an additive applicator, an insect control applicator, a bioactive applicator, a trace element applicator or a validation marker applicator.

The anaesthetic and/or analgesic may be in the form of a fluid, a gel, a powder, a cream, or the like.

In the embodiment illustrated and described here the anaesthetic and/or analgesic applicator 14′ comprises a needle 14a′ that is fluidly connected to a source of anaesthetic and/or analgesic (not illustrated). The needle 14a′ is part of a needle housing 14b′ that is attached to the handle portion 10a′ of the apparatus 10′.

The anaesthetic and/or analgesic applicator 14′ is configured to move between a first, retracted position (FIG. 14a) in which the applicator 14′ is remote from the animal body part, and a second, engaged position (FIG. 14c) in which the applicator 14′ is engaged with the animal body part to deliver anaesthetic and/or analgesic to the animal body part. In this arrangement the needle 14a′ is moved from a first, retracted position (FIG. 14a) in which the needle 14a′ is remote from the animal body part, and a second, engaged position (FIG. 14c) in which the needle 14a′ is engaged with the animal body part to deliver anaesthetic and/or analgesic to the animal body part. In the second position the needle 14a′ delivers anaesthetic and/or analgesic to the animal body part.

In the embodiment illustrated and described here the anaesthetic and/or analgesic applicator 14′/needle 14a′ is operated by a handle 14c′, which works in combination with a pawl & ratchet device 14d′. The pawl & ratchet device 14d′ is also configured to return the anaesthetic and/or analgesic applicator 14′/needle 14a′ to the first position, as described further below. The apparatus 10′ therefore also has an anaesthetic and/or analgesic applicator 14′/needle 14a′ return device, the pawl & ratchet device 14d′ being an example of this. The anaesthetic and/or analgesic applicator 14′ therefore includes a needle 14a′ return feature that returns the needle 14a′ to the first position after it has been moved to the second position. The anaesthetic and/or analgesic applicator 14′ is configured to automatically return to the first, retracted position after movement to the second, engaged position. The anaesthetic and/or analgesic applicator 14′ may be spring biased towards the first, retracted position.

As described further below, the anaesthetic and/or analgesic applicator 14′ is configured to move the needle 14a′ between (i) the first position (FIG. 14a), (ii) the second position (FIG. 14c) and (iii) back to the first position (FIG. 14a).

The anaesthetic and/or analgesic applicator 14′ is adjustable relative to the apparatus. In this arrangement the position of the needle housing 14b′ relative to the handle portion 10a′, or body portion 10d′ may be adjusted to suit the requirements of the user. The adjustment of the position of the needle 14a′ allows the needle 14a′ to penetrate the animal at a different depth, the depth being dependent upon the adjustment of the anaesthetic and/or analgesic applicator 14′ relative to the apparatus 10′.

As described further below, the apparatus 10′ is configured such that the ligature applicator 12′ and the anaesthetic and/or analgesic applicator 14′ can apply the ligature and the anaesthetic and/or analgesic substantially simultaneously. This is very convenient for the user, as it reduces the time required to work on the animal.

Use of the apparatus 10′ will now be described. FIG. 14a illustrates the position where the ligature applicator 12′ is in the first, extended state. The ligature has been omitted for clarity. However, it should be appreciated that the ligature would be mounted on the three pin members 12a′, 12b′, 12c′ in an extended state, ready to be placed over the animal body part to be removed. In this state the user then passes the ligature over the animal body part to be removed. In normal operation the ligature applicator 12′ would then be moved to the second, retracted state to apply the retracted ligature to the animal body part. This would be done by releasing the handle portions 10a′, 10b′ such that the move apart from one another. In FIGS. 14a to 14d the ligature applicator 12′ has been kept in the first, extended state for ease of clarity.

Starting from the initial state of the apparatus 10′ of FIG. 14a where the anaesthetic and/or analgesic applicator 14′ is in the first, retracted position, the user then operates the anaesthetic and/or analgesic applicator 14′ by pushing forward the handle 14c′ towards the animal, as illustrated in FIGS. 14b and 14c. This operation causes the needle 14a′ to move from within the body portion 10d′ of the apparatus 10′ to the second, engaged position and into the animal to inject the animal body part with anaesthetic and/or analgesic. Further operation of the handle 14c′ causes the pawl & ratchet device 14d′ to pull the needle 14a′ back inside the body portion 10d′ of the apparatus 10′ and to the initial first, retracted position. The user then releases the handle 14c′ or moves the handle 14c′ back to the position of FIG. 14a to start the operation again for the next animal. It should be appreciated that this operation would typically be carried out in one movement by the user.

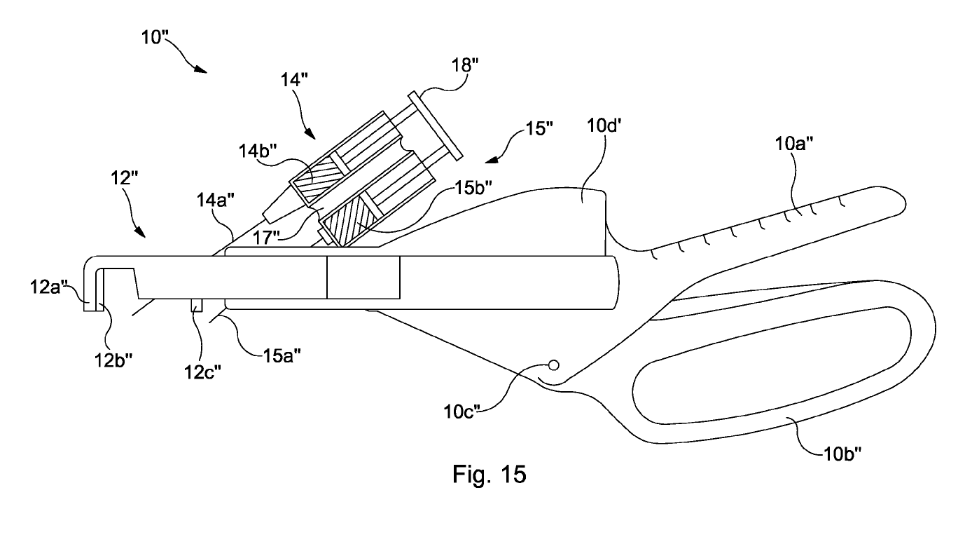

FIG. 15 illustrates an apparatus 10″ for removal of an animal body part. The apparatus 10″ includes a ligature applicator 12″ and an anaesthetic and/or analgesic applicator 14″ (an example of an anaesthetic and/or analgesic applicator or a substance applicator) and a vaccine applicator 15″ (an example of a substance applicator or a further substance applicator). As described further below, the ligature applicator 12″ is configured to move a ligature (not illustrated) between a first, extended state in which the ligature can be passed over the animal body part (not illustrated) to a selected application position, and a second, retracted state in which the ligature applies a compressive force at the application position to restrict blood flow in the animal body part. The operation of the ligature applicator 12″ is essentially the same as the ligature applicator 12′ described above.

The apparatus 10″ is configured to operate with a rubber/latex ring, such as the ring 14 described above. The ligature may be a closed elastic ligature capable of being applied in a stretched condition.

In the embodiment illustrated and described here the ligature applicator 12″ comprises three pin members (examples of members) 12a″, 12b″, 12c″. The three pin members 12a″, 12b″, 12c″ are moveable relative to one another. The three pin members 12a″, 12b″, 12c″ are moved by operation of two handle portions 10a″, 10b″, as described below. The three pin members 12a″, 12b″, 12c″ of the ligature applicator 12″ are configured to engage with and move the ligature from an initial, retracted state to the first, extended state. As described further below, this may be done before the ligature applicator 12″ moves to the second, retracted state. The three pin members 12a″, 12b″, 12c″ are also moveable, or pivotable, between a first position in which a ligature may be held in an extended state and a second position in which the ligature may be allowed to disengage from the members. This assists in disengagement of the ligature from the three pin members 12a″, 12b″, 12c″.

As illustrated, the apparatus 10″ is in the form of a hand tool and includes two handle portions 10a″ 10b″ and a body portion 10d″. The handle portions 10a″, 10b″ are pivotably connected to one another about a pivot point 10c″. The ligature applicator 12″, the anaesthetic and/or analgesic applicator 14″ and the vaccine applicator 15″ are connected to the body portion 10d″.

The apparatus 10″ is configured such that movement of the two handle portions 10a″, 10b″ operates the ligature applicator 12″. As described below, movement of the two handle portions 10a″, 10b″ operates the ligature applicator 12′ to move the ligature between the first, extended state and the second, retracted state. Movement of the two handle portions 10a″, 10b″ results in movement of the ligature applicator 12″ between the first and second positions. In the embodiment illustrated and described here movement of the two handle portions 10a″, 10b″ results in movement pin members 12a″ and 12b″ relative to the handle portions 10a″, 10b″, pin member 12c″ being held in a fixed position. In this arrangement pin members 12a″ and 12b″ move away from pin member 12c″ when the handle portions 10a″, 10b″ are brought together.

The anaesthetic and/or analgesic applicator 14″ is configured to deliver an anaesthetic and/or analgesic to the animal body part and the vaccine applicator 15″ is configured to deliver a vaccine to the animal body part. However, it should be appreciated that the substance may not necessarily be a vaccine and may be an alternative selected from one or more of the group consisting of: medicines, medicinal products, medicinal treatments, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements and validation markers. The apparatus 10″ may therefore be configured to deliver anaesthetic and/or analgesic and a further substance to the animal. In one arrangement the apparatus 10′ may be configured to deliver an anaesthetic and/or analgesic and a vaccine to the animal.

In the embodiment illustrated and described here the anaesthetic and/or analgesic applicator 14″ comprises a needle 14a″ that is fluidly connected to a source of anaesthetic and/or analgesic 14b″, and the vaccine applicator 15″ comprises a needle 15a″ that is fluidly connected to a source of vaccine 15b″. The needles 14a″, 15a″ are part of a needle housing 17″ that is attached to the handle portion 10a″ of the apparatus 10″. It should be appreciated that the needles 14a″, 15a″ may be moveable between a first retracted position and a second engaged position, as described above.

In the arrangement illustrated and described here the anaesthetic and/or analgesic applicator 14″ and the vaccine applicator 15″ are configured to be operable simultaneously via operation of the needle plunger 18″. However it should be appreciated that the anaesthetic and/or analgesic applicator 14″ and the vaccine applicator 15″ may be configured to be independently operable via separate needle plungers. It should also be appreciated that, although the apparatus 10″ is illustrated and described here as having a source of anaesthetic and/or analgesic 14b″ and a separate source of vaccine 15b″, the apparatus 10″ may have a single source of both anaesthetic and/or analgesic and vaccine. That is the anaesthetic and/or analgesic and vaccine may be mixed together in a single source (e.g. chamber). In this arrangement the apparatus 10″ may only require a single applicator with a single delivery mechanism (i.e. needle). It should also be appreciated that the apparatus 10″ may include an arrangement whereby the apparatus 10″ includes a single applicator with a single delivery mechanism (i.e. needle) and the single applicator is selectively connected to a source of anaesthetic and/or analgesic or a source of vaccine. In this arrangement the applicator may include a valve that is operable to connect the source of anaesthetic and/or analgesic or the source of vaccine to the applicator. The valve being operable by the user to select the substance to be delivered to the animal.

Operation of the ligature applicator 12″ is the same as described in relation to FIGS. 14a to 14d. One the ligature is applied to the animal the anaesthetic and/or analgesic applicator 14″ and the vaccine applicator 15″ are operated to deliver the respective substances to the animal.

The apparatuses 10′, 10″ of the present invention therefore provide for substantially simultaneous application of a ligature and delivery of an anaesthetic and/or analgesic and/or vaccine to an animal.

In all cases where straps or cords are used, it is desirable that the strap remains tensioned in a closing direction after application, in order to close further as the scrotal tissue atrophies. This may be achieved by forming the strap of an elastic material such as rubber. It could also be achieved by using a non-elastic strap in conjunction with a biasing means such as a spring or resilient member.

Reference herein to “anaesthetic” is intended to cover any substance with sensation eliminating properties and reference herein to “analgesic” is intended to cover any substance with pain-reducing or pain-relieving properties.

As noted above, although the present invention has been described with particular reference to the castration of lambs it is also applicable to procedures for removal of other body parts. It may for example be used for the castration of other male mammals such as calves and pigs, for tail docking for example of lambs and pigs, and for de-horning.

Also, the present invention has been illustrated and described above as applying a ligature and an anaesthetic and/or analgesic to an animal body part. However, it should also be appreciated that the present invention may also be used to apply a ligature and another substance to an animal body. As described above, the substance may be one of a number of compounds, compositions etc., or a mixture thereof.

The device and apparatus may also be used as a tourniquet on humans or animals. For example, it could be used to sequentially or simultaneously mitigate bleeding and administer anaesthetic to a person in need thereof. It should also be appreciated that the substance applicator(s) are configurable to deliver a substance, or substances, to the animal when the apparatus is in use. The substance, or substances, themselves do not form part of the invention in its broadest sense. It should also be appreciated that the ligature applicator is configurable to apply a ligature to the animal when the apparatus is in use. The ligature itself does not form part of the invention in its broadest sense. For the avoidance of doubt, the ligature applicator is merely configurable to be used with a ligature as described, the ligature is not part of the claimed apparatus, and the substance applicator(s) are merely configurable to deliver a substance, or substances, to the animal, the substance, or substances, are not part of the claimed apparatus.

Modifications and improvement may be made to the above without departing from the scope of the present invention.

1. An apparatus for removal of an animal body part, the apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a substance applicator, the substance applicator being configured to deliver a substance to the animal.

2. to 6. (canceled)

7. The apparatus of claim 1, wherein the ligature applicator is configured to engage with and move the ligature from an initial, retracted state to the first, extended state.

8. The apparatus of claim 1, wherein the ligature applicator includes at least two members, the at least two members being movable relative to one another.

9. The apparatus of claim 8, wherein the at least two members are configured to move between a first position in which a retracted ligature may be applied to the ligature applicator, and a second position in which the ligature is in the extended state.

10. The apparatus of claim 8, wherein the ligature applicator includes three members, the three members being moveable relative to one another.

11. The apparatus of 8, wherein the members of the ligature applicator are protrusions, protruding pins or pin members.

12. The apparatus of 8, wherein the members are moveable between a first position in which a ligature may be held in an extended state and a second position in which the ligature may be allowed to disengage from the members.

13. The apparatus of claim 1, wherein the apparatus is a hand tool comprising two handle portions, the two handle portions being pivotably connected to one another, wherein the apparatus is configured such that movement of the two handle portions operates the ligature applicator to move the ligature between the first, extended state and the second, retracted state.

14. to 16. (canceled)

17. The apparatus of claim 1, wherein the substance applicator is configured to move between a first, retracted position in which the substance applicator is remote from the animal body part, and a second, engaged position in which the substance applicator is engaged with the animal body part to deliver a substance to the animal body part.

18. The apparatus of claim 1, wherein the substance applicator is configured to inject the substance to the animal.

19. The apparatus of claim 17, wherein the substance applicator is biased towards the first, retracted position.

20. The apparatus of claim 17, wherein the substance applicator is configured to automatically return to the first, retracted position after movement to the second, engaged position.

21. to 23. (canceled)

24. The apparatus of claim 1, wherein the substance applicator comprises one or more needles.

25. The apparatus of claim 24, wherein the one or more needles are hypodermic needles, or microneedles.

26. The apparatus of claim 25, wherein the one or more needles or microneedles are moveable between the first and second positions to deliver the substance to the animal.

27. (canceled)

28. The apparatus of claim 1, wherein the substance applicator is moveable relative to the apparatus.

29. The apparatus of claim 1, wherein the apparatus is configured such that the ligature applicator and the substance applicator can apply the ligature and the substance to the animal substantially simultaneously.

30. The apparatus of claim 1, wherein the apparatus comprises two or more substance applicators.

31. to 46. (canceled)

47. A method of removing an animal body part comprising the steps of:
providing an apparatus comprising:
a ligature applicator, the ligature applicator being configured to move a ligature between a first, extended state in which the ligature can be passed over the animal body part to a selected application position, and a second, retracted state in which the ligature applies a compressive force at the application position to restrict blood flow in the animal body part; and
a substance applicator, the substance applicator being configured to deliver a substance to the animal;
providing a ligature to the ligature applicator;
operating the ligature applicator to move the ligature to the first, extended state;
locating the animal body part to be removed within the ligature;
operating the ligature applicator to move the ligature to the second, retracted state; and
operating the substance applicator to deliver a substance to the animal.

48. to 69. (canceled)

70. An apparatus for removal of an animal body part, the apparatus comprising:
a ligature applicator, the ligature applicator being configured to move a ligature between an initial, retracted state and an intermediate extended state in which the ligature can be passed over the animal body part to a selected application position, and then to a final, retracted state in which the ligature applies a compressive force at the application position to restrict blood flow in the animal body part; and
a substance applicator, the substance applicator being configured to inject a substance to the animal.
